(19) United States
(12) Patent Application Publication
(10) Pub. No.: US 2015/0176571 A1
(43) Pub. Date: Jun. 25, 2015

(54) WIND TURBINE ROTARY ELECTRIC MACHINE, WIND TURBINE, AND METHOD OF ASSEMBLING A ROTARY ELECTRIC MACHINE TO A WIND TURBINE

(71) Applicant: Wilic S.AR.L., Luxembourg (LU)

(72) Inventors: Paolo Bustreo, Bolzano (IT); Paolo Toccoli, Luxembourg (LU); Matteo Casazza, Val Di Vizze (IT)

(21) Appl. No.: 14/417,055

(22) PCT Filed: Jul. 25, 2013
(86) PCT No.: PCT/IB2013/056121

§ 371 Date: Jan. 23, 2015

(30) Foreign Application Priority Data
Jul. 25, 2012 (IT) MI2012A001305

(51) Int. Cl. F03D 11/02; H02K 15/02; F03D 9/00; H02K 1/30; H02K 7/102

(52) U.S. Cl. CPC F03D 11/028; H02K 1/30; H02K 7/102; F03D 9/002; H02K 15/02

(57) ABSTRACT

A wind turbine rotary electric machine has an active part having a plurality of axial active segments arranged about an axis of rotation; and a tubular structure, which extends about the axis of rotation, supports the active segments, and is divided into a plurality of first sectors connected to one another and configured to fit to a frame of the wind turbine.

### PRIORITY CLAIM

This application is a national stage application of PCT/IB2013/056121, filed on Jul. 25, 2013, which claims the benefit of and priority to Italian Patent Application No. MI2012A 001305, filed on Jul. 25, 2012, the entire contents of which are each incorporated by reference herein.

### BACKGROUND

Certain known wind turbine rotary electric machines, particularly those used on large-diameter wind turbines, must have special characteristics, as compared with ordinary rotary electric machines. For example, they must be relatively lightweight, must be relatively easily accessible for maintenance, and their component parts must be relatively easy to assemble and disassemble, both when installing and servicing the machine. Moreover, the rotary electric machine must be relatively easily connectable to the main frame and the blade assembly, and must be so designed as not to require excessively large, heavy main frames.

In wind turbine technology, the trend is towards increasingly powerful (i.e., large-diameter, rotary electric machines). This trend, however, poses problems in terms of the weight and size of the rotary electric machine and its component parts, which in turn pose problems both in transporting the rotary electric machine to the wind turbine installation site, and in assembling the rotary electric machine itself. To meet demand for increasingly high output, manufacturers have been forced to produce wind turbines with extremely large-diameter blade assemblies, thus increasing the height at which the rotary electric machines must be installed.

Electric machines of the above-identified type and installed in wind turbines are disclosed in PCT Patent Application No. WO02/099950 and EP Patent No. 1,988,282.

### SUMMARY

The present disclosure relates to a wind turbine rotary electric machine.

It is an advantage of the present disclosure to provide a wind turbine rotary electric machine, in particular a large-diameter rotary electric machine, that is relatively easy to transport, install and maintain.

According to the present disclosure, there is provided a rotary electric machine for a wind turbine, the rotary electric machine comprising: a first active part comprising a plurality of axial first active segments arranged about an axis of rotation; and a first tubular structure, which extends about the axis of rotation, supports the first active segments, and is divided into a plurality of first sectors connected to one another and configured to fit to a frame of the wind turbine; and a rotary mechanical assembly comprising a sleeve configured to fit to the frame of the wind turbine, a hub configured to fit to the sleeve and rotate about the axis of rotation; and a bearing configured to withstand radial and axial forces and located between the hub and the sleeve; characterized in that the hub is configured to extend inside and outside the sleeve.

By dividing the first tubular structure into first sectors, and the first active part into first segments, part of the electric machine can be assembled on site, thus solving the problems posed by transporting and assembling large structures.

In the case in hand, the first tubular structure and the relative first active part define a tubular stator of the rotary electric machine. So it is the entire tubular stator that is divided into a plurality of component parts that can be assembled at the wind turbine installation site.

The hub of the rotary mechanical assembly thus rotates about the axis of rotation with respect to the sleeve.

This configuration permits relatively easy removal and/or replacement of the bearing.

In certain embodiments of the present disclosure, each first sector is configured to support a plurality of first active segments.

In dividing up the tubular stator, the active part is divided up into more parts than the tubular structure. This is because the active segments call for frequent maintenance and sometimes need replacing, whereas the tubular structure is divided up for practical reasons of transport and assembly.

In certain embodiments, each first sector and each first active segment are configured to form an axially slidable prismatic joint. This configuration relatively simplifies assembly and removal of the active segments.

In certain embodiments, each first sector comprises a tubular portion; and an annular portion, which in certain embodiments is integral with the tubular portion.

The annular portion also serves for protection.

The sleeve forms part, and represents the fixed part, of the rotary mechanical assembly.

The rotary mechanical assembly is tubular, and is much smaller in diameter than the first tubular structure.

In certain embodiments of the present disclosure, the rotary electric machine comprises a first radial structure extending radially from the sleeve to the first tubular structure to support the first sectors of the first tubular structure.

The first radial structure serves to support the first tubular structure at a designated or given distance from the axis of rotation. In certain embodiments, the first radial structure comprises a plurality of modules; and each module is independent of the other modules and is associated with a respective sector.

The first radial structure is thus also modular, and can be divided into a plurality of component parts for relatively easy transport and assembly.

In certain embodiments, the first radial structure is adjustable radially to adjust the distance between the first and a second active part.

In certain embodiments, the first radial structure comprises first tie spokes.

In certain embodiments, the rotary mechanical assembly comprises a braking system.

More specifically, the braking system extends between the hub and the sleeve.

In certain embodiments, the braking system comprises a brake disk fitted to or integral with the hub; and at least one brake calliper fitted to the sleeve and configured to engage the brake disk.

In certain embodiments, the rotary mechanical assembly comprises a locking system configured to lock the hub to the sleeve. This makes it possible to remove the bearing relatively easily, or to insert or remove the first active segments and/or first sectors.

In certain embodiments of the present disclosure, the rotary electric machine comprises a second active part facing the first active part and comprising a plurality of axial second active segments arranged about the axis of rotation; and a second tubular structure, which extends about the axis of rotation, supports the second active segments, and is divided into a plurality of second sectors connected to one another and configured to fit to the hub. In other words, the modular design or configuration is also applied to the second active part and second tubular structure. So the rotor, even when of large diameter, can be transported relatively easily and assembled on site.

In certain embodiments of the present disclosure, the rotary electric machine comprises a second radial structure extending radially from the hub to the second tubular structure to support the second sectors of the second tubular structure.

The second radial structure serves to firmly support the second tubular structure at a designated or given distance from the axis of rotation.

In certain embodiments, the second radial structure is divided into a plurality of second modules; each second module being associated with a respective second sector.

The modular design or configuration of the second radial structure makes the second radial structure relatively easier to transport and assemble.

In certain embodiments, the second radial structure is adjustable radially to adjust the distance between the first and second active part.

In certain embodiments, the second radial structure comprises second tie spokes.

The tie spokes greatly reduce the weight of the second radial structure, and make the second radial structure relatively easy to divide into second modules.

A further advantage of the present disclosure is to provide a wind turbine configured to eliminate certain of the drawbacks of certain of the known art.

According to the present disclosure, there is provided a wind turbine configured to produce electric energy, the wind turbine comprising a frame; a blade assembly; and a rotary electric machine having any one of the above-listed characteristics and connected directly to the frame and the blade assembly.

A further advantage of the present disclosure is to provide a method of assembling a rotary electric machine to a wind turbine, configured to eliminate certain of the drawbacks of certain of the known art.

According to the present disclosure, there is provided a method of assembling a rotary electric machine to a wind turbine, the method comprising the steps of assembling a rotary mechanical assembly, configured to rotate about an axis of rotation of the rotary electric machine, to a frame of the wind turbine; and assembling first and second sectors, fitted to a first and second radial structure, about the axis of rotation and to the rotary mechanical assembly to respectively form a first and second tubular structure coaxial with each other.

In the present disclosure, the large-diameter component parts are divided into sectors and assembled about the rotary mechanical assembly.

In certain embodiments of the present disclosure, the method comprises inserting first and second segments axially into respective seats on the first and second tubular structure respectively, to form a first and second tubular active part facing each other.

The first and second active part, separated by a relatively small air gap, are thus assembled later, to reduce the risk of contact and damage.

Additional features and advantages are described in, and will be apparent from the following Detailed Description and the figures.

### BRIEF DESCRIPTION OF THE DRAWINGS

A number of non-limiting embodiments of the present disclosure will be described by way of example with reference to the attached drawings, in which:

FIG. 1 shows a section, with parts removed for clarity, of a wind turbine equipped with a rotary electric machine in accordance with the present disclosure;

FIG. 2 shows a larger-scale, partly sectioned side view, with parts removed for clarity, of a detail of the FIG. 1 rotary electric machine;

FIG. 3 shows a larger-scale view in perspective, with parts removed for clarity, of a component part of the FIG. 1 rotary electric machine;

FIGS. 4 and 5 show partly sectioned side views, with parts removed for clarity, of a detail of the rotary electric machine in accordance with a variation of the present disclosure; and

FIG. 6 shows a larger-scale view in perspective, with parts removed for clarity, of a module of the radial structure shown in FIG. 5.

### DETAILED DESCRIPTION

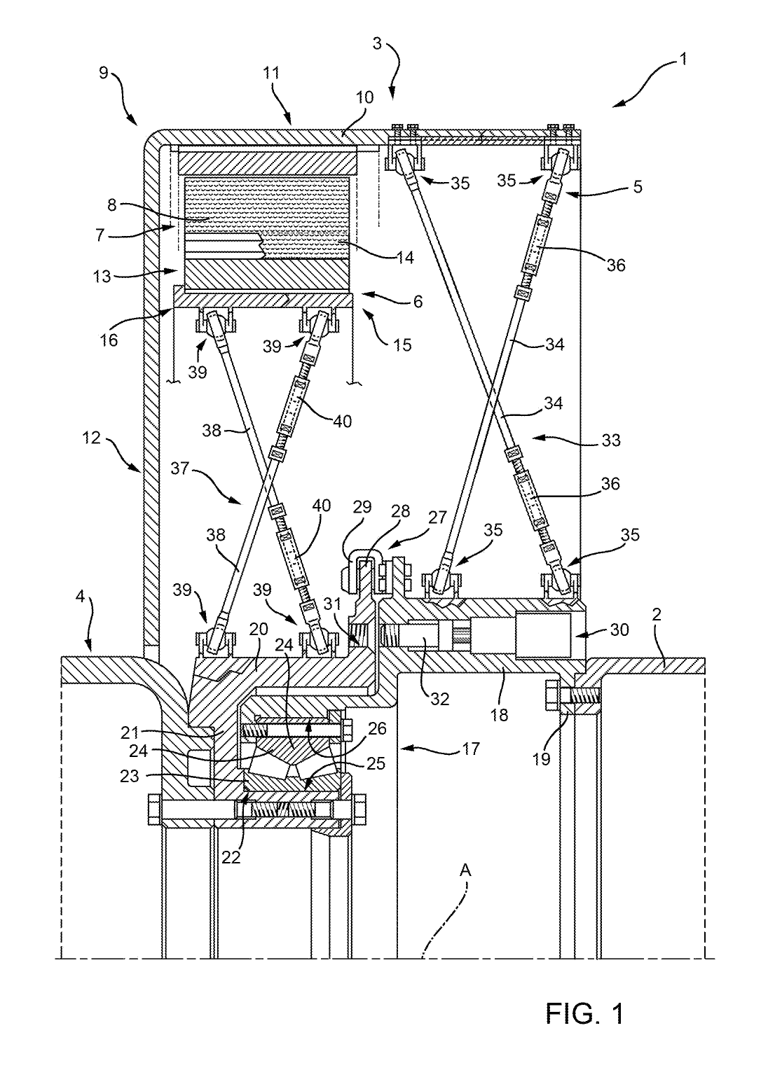

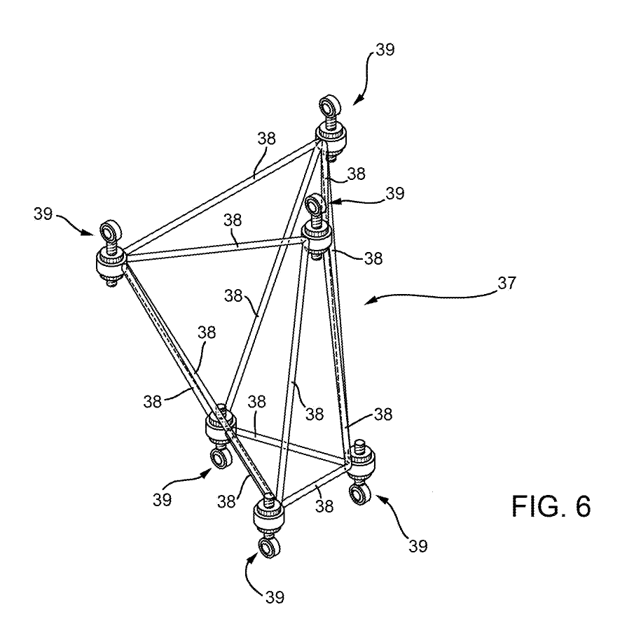

Referring now to the example embodiments of the present disclosure illustrated in FIGS. 1 to 6, number 1 in FIG. 1 indicates as a whole a wind turbine configured to produce electric energy. Wind turbine 1 comprises a main frame 2; a rotary electric machine 3 fitted to frame 2; and a blade assembly 4 mounted to rotate about an axis of rotation A of rotary electric machine 3.

In certain embodiments, wind turbine 1 is a direct-drive type (i.e., in which blade assembly 4 is connected directly to rotary electric machine 3 with no mechanical transmissions in between).

Rotary electric machine 3 is tubular, and, in certain embodiments, asynchronous with permanent magnets.

Rotary electric machine 3 is interposed between frame 2 and blade assembly 4, and serves to support the blade assembly, and to transmit the stress generated in blade assembly 4 to rotary electric machine 3 itself.

Rotary electric machine 3 comprises a tubular stator 5 and a tubular rotor 6. In the example shown, tubular rotor 6 is located inside tubular stator 5, but the present disclosure also applies to configurations in which the tubular rotor surrounds the tubular stator.

Tubular stator 5 comprises a tubular active part 7, which extends about axis of rotation A and comprises a plurality of axial active segments 8.

Tubular stator 5 comprises a tubular structure 9, which extends about axis of rotation A, is configured to support active segments 8, and is divided into a plurality of sectors 10 connected to one another and configured to fit to frame 2 of wind turbine 1.

Sectors 10 are arc-shaped and, in certain embodiments, identical.

Each sector 10 is configured to support a plurality of active segments 8. In other words, sectors 10 extend along a wider angle than active segments 8. And, in the example shown, tubular structure 9 comprises two sectors 10, each extending 180° about axis of rotation A.

Each sector 10 and each active segment 8 are configured to form an axially slidable prismatic joint.

Each sector 10 comprises a tubular portion 11; and an annular portion 12, which is, in certain embodiments, integral with tubular portion 11. Tubular portion 11 serves to support active segments 8, while annular portion 12 acts as a protective casing.

It should be appreciated that dividing tubular structure 9 into two sectors is in no way to be intended as limiting the scope of the present disclosure.

Likewise, tubular rotor 6 comprises a tubular active part 13, which faces active part 7, extends about axis of rotation A, and comprises a plurality of axial active segments 14.

Tubular rotor 6 comprises a tubular structure 15, which extends about axis of rotation A, is configured to support active segments 14, and is divided into a plurality of sectors 16 connected to one another.

Sectors 16 are arc-shaped and, in certain embodiments, identical.

Each sector 16 is configured to support a plurality of active segments 14. In other words, sectors 16 extend along a wider angle than active segments 14. And, in the example shown, tubular structure 15 comprises twenty sectors 16, each extending 36° about axis of rotation A.

It should be appreciated that dividing tubular structure 15 into twenty sectors is in no way to be intended as limiting the scope of the present disclosure.

Each sector 16 and each active segment 14 are configured to form an axially slidable prismatic joint.

Rotary electric machine 3 comprises a rotary mechanical assembly 17 interposed between frame 2 and blade assembly 4, and configured to permit rotation of tubular rotor 6 with respect to tubular stator 5, to brake tubular rotor 5, and to fix tubular rotor 5 to tubular stator 6.

Rotary electric machine 3—in the example shown, rotary mechanical assembly 17—comprises a sleeve 18 fixed, such as bolted, to frame 2. For which purpose, sleeve 18 comprises a flange 19. In certain embodiments, sleeve 18 decreases axially in diameter, from frame 2 towards blade assembly 4.

Rotary electric machine 3—in the example shown, rotary mechanical assembly 17—comprises a hub 20 configured to fit to sleeve 18 and rotate about axis of rotation A.

Hub 20 is connected directly to blade assembly 4. For which purpose, hub 20 comprises a flange 21 configured to connect, such as by bolting, the hub to blade assembly 4.

Rotary electric machine 3—in the example shown, rotary mechanical assembly 17—comprises a bearing 22 configured to withstand radial and axial forces and located between hub 20 and sleeve 18. Bearing 22 comprises an inner ring 23 and an outer ring 24.

Hub 20 comprises an annular pocket 25 configured to house inner ring 23 of bearing 22.

Sleeve 18 comprises an annular pocket 26 configured to house outer ring 24 of bearing 22.

Hub 20 has a substantially C-shaped cross section extending about the free end of sleeve 18.

In certain embodiments, hub 20 is configured to extend inside and outside sleeve 18.

Rotary mechanical assembly 17 comprises a braking system 27 fitted to sleeve 18 and hub 20. In certain embodiments, braking system 27 comprises a brake disk 28 fitted to or formed integrally with hub 20; and at least one brake calliper 29 fitted to sleeve 18 and configured to engage the brake disk 28. Brake disk 28 extends about sleeve 18 or at least about an end portion of sleeve 18.

Rotary mechanical assembly 17 comprises a locking system 30 configured to lock hub 20 to sleeve 18.

More specifically, locking system 30 comprises lock members 31 fitted to sleeve 18; and lock members 32 located along hub 20 and configured to interact with lock members 31.

Accordingly, rotary mechanical assembly 17, provides for rotating hub 20 about axis of rotation A with respect to sleeve 18, mechanically braking hub 20 with respect to sleeve 18, and locking hub 20 to sleeve 18.

Locking hub 20 to sleeve 18 enables removal and replacement of bearing 22. For which purpose, sleeve 18 and hub 20 are configured to permit removal of bearing 22 from the frame 2 side, once hub 20 is locked to sleeve 18.

Rotary mechanical assembly 17 can be assembled to frame 2 and blade assembly 4 without tubular stator 5 and tubular rotor 6. In other words, tubular rotor 6 and tubular stator 5 can be assembled about rotary mechanical assembly 17 already installed in position. Assembling tubular rotor 6 and tubular stator 5 later is made possible by respective tubular structures 15 and 9 being divided into respective sectors 16 and 10, and by respective active parts 13 and 7 being divided into respective segments 14 and 8.

Tubular stator 5 is connected to sleeve 18. More specifically, rotary electric machine 3 comprises a radial structure 33 extending radially from sleeve 18 to tubular structure 9 to support sectors 10 of tubular structure 9.

In certain embodiments, radial structure 33 is divided into modules, each associated with a respective sector 10.

In certain embodiments, radial structure 33 is adjustable radially.

In certain embodiments, radial structure 33 comprises tie spokes 34. Tie spokes 34 are configured to mainly withstand tensile stress. Tie spokes 34 enable radial structure 33 to be divided relatively easily into modules.

In certain embodiments, tie spokes 34 are mounted tangentially with respect to sleeve 18, so as to also withstand moments transmitted by tubular structure 9 to sleeve 18.

Tie spokes 34 of radial structure 33 are arranged in two rows, and cross axially to withstand axial stress.

Tie spokes 34 are connectable to sleeve 18 and tubular structure 9 using ball joints 35. Each tie spoke 34 also comprises a nipple 36 configured to adjust the pull, and therefore the length, of tie spoke 34.

Tubular rotor 6 is connected to hub 20. More specifically, rotary electric machine 3 comprises a radial structure 37 extending radially from hub 20 to tubular structure 15 to support sectors 16 of tubular structure 15.

In certain embodiments, radial structure 37 is adjustable radially.

In certain embodiments, radial structure 37 is also divided into modules, each associated with a respective sector 16.

In certain embodiments, radial structure 37 comprises tie spokes 38 configured to mainly withstand tensile stress.

In certain embodiments, tie spokes 38 are mounted tangentially with respect to hub 20, so as to also withstand moments transmitted by tubular structure 15 to hub 20.

Tie spokes 38 of radial structure 37 are arranged in two rows, and cross axially to withstand axial stress.

Tie spokes 38 are connectable to hub 20 and tubular structure 15 using ball joints 39. Each tie spoke 38 also comprises a nipple 40 configured to adjust the pull and length of tie spoke 38.

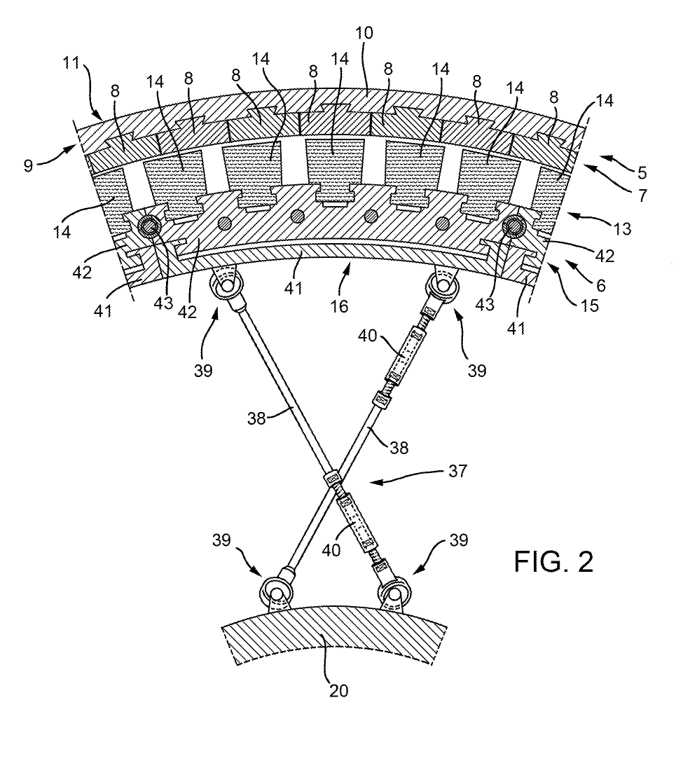

With reference to FIG. 2, each sector 16 comprises a base 41 with a seat; and an insert 42 that can be selectively fitted axially inside the seat on base 41. Insert 42 in turn comprises a plurality of seats, into which active segments 14 can be selectively fitted axially. Each active segment 14 is configured to fit inside a respective seat in the insert.

Tubular rotor 6 also comprises expansion plugs 43, each located between two adjacent sectors 16 to transmit circumferential force and eliminate any slack between sectors 16, and so stabilize tubular structure 15.

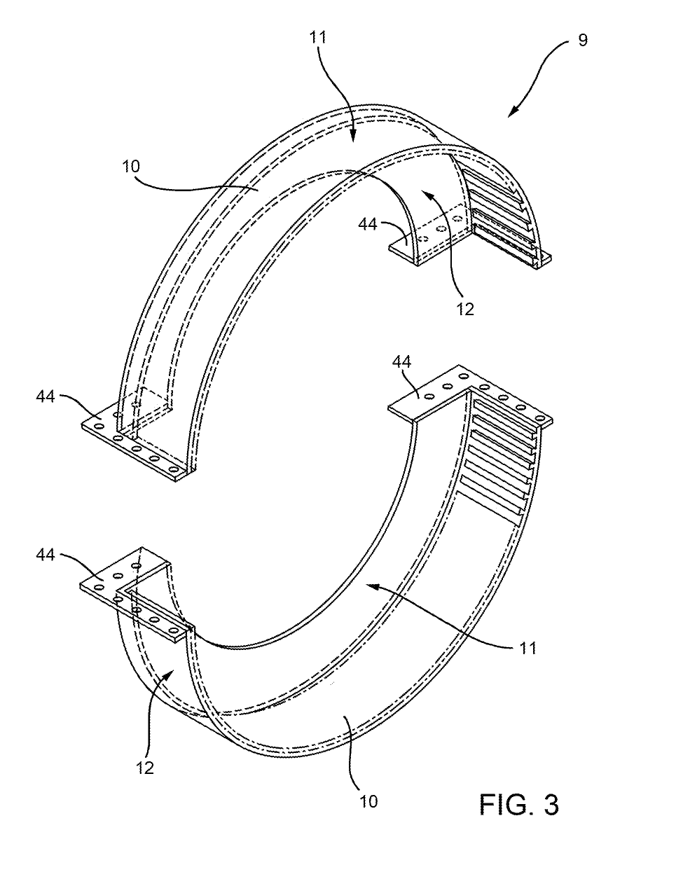

With reference to FIG. 3, each sector 10 of tubular structure 9 has flanges 44 configured to connect sector 10 to adjacent sectors 10, or to the adjacent sector 10 in the example shown, in which tubular structure 15 comprises two semicylindrical sectors 10.

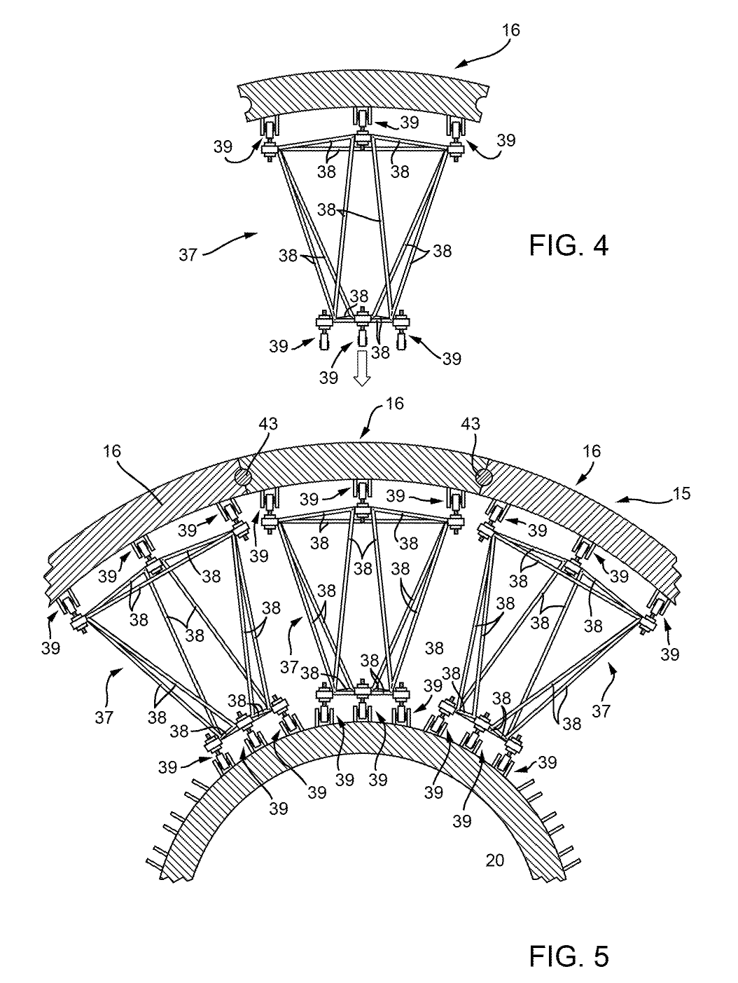

FIGS. 4, 5 and 6 show a variation of radial structure 37, in which tie spokes 38 are arranged in a trellis pattern to support sectors 16, to better withstand axial, radial and tangential stress, and to support each sector 16 with no assistance from adjacent sectors 16.

Radial structure 37 may also have a spoke pattern as shown in FIGS. 4-6.

In short, the present disclosure provides for relatively easily and relatively cheaply transporting and installing large-diameter rotary electric machines.

According to the present disclosure, rotary mechanical assembly 17 can be fitted to the wind turbine frame 2, and the rotary electric machine assembled about rotary mechanical assembly 17.

Clearly, changes may be made to the rotary electric machine according to the present disclosure without, however, departing from the scope of the accompanying Claims. That is, various changes and modifications to the presently disclosed embodiments will be apparent to those skilled in the art. Such changes and modifications can be made without departing from the spirit and scope of the present subject matter and without diminishing its intended advantages. It is therefore intended that such changes and modifications be covered by the appended claims.

1-30. (canceled)

31. A wind turbine rotary electric machine comprising:
a first active part including:
a plurality of axial first active segments arranged about an axis of rotation, and
a first tubular structure which: (i) extends about the axis of rotation, (ii) supports the axial first active segments, and (ii) is divided into a plurality of first sectors connected to one another and configured to fit to a frame of a wind turbine; and
a rotary mechanical assembly including:
a sleeve configured to fit to the frame of the wind turbine,
a hub configured to: (i) fit to the sleeve, (ii) extend inside and outside the sleeve, and (iii) rotate about the axis of rotation, and
a bearing configured to withstand radial forces and axial forces, said bearing being located between the hub and the sleeve.

32. The wind turbine rotary electric machine of claim 31, wherein each first sector is configured to support a plurality of the axial first active segments.

33. The wind turbine rotary electric machine of claim 31, wherein at least one of the first sectors and at least one of the axial first active segments are configured to form an axially slidable prismatic joint.

34. The wind turbine rotary electric machine of claim 31, wherein each first sector includes a tubular portion and an annular portion.

35. The wind turbine rotary electric machine of claim 34, wherein the annular portion is integral with the tubular portion.

36. The wind turbine rotary electric machine of claim 31, which includes a first radial structure extending radially from the sleeve to the first tubular structure to support the first sectors of the first tubular structure.

37. The wind turbine rotary electric machine of claim 36, wherein the first radial structure is radially adjustable.

38. The wind turbine rotary electric machine of claim 36, wherein the first radial structure includes a plurality of modules, and each module is independent of the other modules and is associated with a respective one of the first sectors.

39. The wind turbine rotary electric machine of claim 36, wherein the first radial structure includes a plurality of first tie spokes.

40. The wind turbine rotary electric machine of claim 39, wherein the first tie spokes of the first radial structure are tangential spokes.

41. The wind turbine rotary electric machine of claim 39, wherein the first tie spokes of the first radial structure are arranged in two rows.

42. The wind turbine rotary electric machine of claim 41, wherein the first tie spokes in the two rows cross axially.

43. The wind turbine rotary electric machine of claim 31, wherein:
the bearing includes:
an inner ring, and
an outer ring,
the hub includes a first annular pocket configured to house the inner ring of the bearing, and
the sleeve includes a second annular pocket configured to house the outer ring of the bearing.

44. The wind turbine rotary electric machine of claim 31, wherein the rotary mechanical assembly includes a braking system.

45. The wind turbine rotary electric machine of claim 44, wherein the braking system includes a brake disk, said brake disk being one of: fitted to the hub or integral with the hub.

46. The wind turbine rotary electric machine of claim 45, wherein the braking system includes at least one brake calliper fitted to the sleeve and configured to engage the brake disk.

47. The wind turbine rotary electric machine of claim 31, wherein the hub includes an annular flange configured to form a connection to a blade assembly of the wind turbine.

48. The wind turbine rotary electric machine of claim 31, wherein the rotary mechanical assembly includes a locking system configured to lock the hub to the sleeve.

49. The wind turbine rotary electric machine of claim 31, which includes a second active part facing the first active part, said second active part including:
a plurality of axial second active segments arranged about the axis of rotation, and
a second tubular structure which: (i) extends about the axis of rotation, (ii) supports the axial second active segments, and (iii) is divided into a plurality of second sectors connected to one another and configured to fit to the hub.

50. The wind turbine rotary electric machine of claim 49, wherein each second sector is configured to support a plurality of the axial second active segments.

51. The wind turbine rotary electric machine of claim 49, wherein at least one of the second sectors and at least one of the axial second active segments are configured to form an axially slidable prismatic joint.

52. The wind turbine rotary electric machine of claim 49, which includes a second radial structure extending radially from the hub to the second tubular structure to support the second sectors of the second tubular structure.

53. The wind turbine rotary electric machine of claim 52, wherein the second radial structure is radially adjustable.

54. The wind turbine rotary electric machine of claim 52, wherein the second radial structure is divided into a plurality of second modules, each second module being associated with a respective one of the second sectors.

55. The wind turbine rotary electric machine of claim 52, wherein the second radial structure includes a plurality of second tie spokes.

56. The wind turbine rotary electric machine of claim 55, wherein the second tie spokes of the second radial structure are tangential spokes.

57. The wind turbine rotary electric machine of claim 51, wherein the second tie spokes of the second radial structure are arranged in two rows.

58. The wind turbine rotary electric machine of claim 57, wherein the second tie spokes in the two rows cross axially.

59. An electric energy producing wind turbine comprising:
a frame;
a blade assembly; and
a rotary electric machine directly connected to the frame and the blade assembly, said rotary electric machine including:
a first active part including:
a plurality of axial first active segments arranged about an axis of rotation, and
a first tubular structure which: (i) extends about the axis of rotation, (ii) supports the axial first active segments, and (ii) is divided into a plurality of first sectors connected to one another and configured to fit to the frame, and
a rotary mechanical assembly including:
a sleeve configured to fit to the frame,
a hub configured to: (i) fit to the sleeve, (ii) extend inside and outside the sleeve, and (iii) rotate about the axis of rotation, and
a bearing configured to withstand radial forces and axial forces, said bearing being located between the hub and the sleeve

60. A method of assembling a rotary electric machine, the method comprising:
assembling a rotary mechanical assembly configured to rotate about an axis of rotation of the rotary electric machine to a frame of a wind turbine, said a rotary mechanical assembly including: a sleeve configured to fit to the frame, a hub configured to: (i) fit to the sleeve, (ii) extend inside and outside the sleeve, and (iii) rotate about the axis of rotation, and a bearing configured to withstand radial forces and axial forces, said bearing being located between the hub and the sleeve; and
assembling, about the axis of rotation, a first sector fitted to a first radial structure and a second sector fitted to a second radial structure to the rotary mechanical assembly to respectively form a first tubular structure and a second tubular structure, said first tubular structure and the second tubular structure being coaxial with each other.

61. The method of claim 60, which includes:
inserting a plurality of first segments axially into a plurality of seats on the first tubular structure to form a first tubular active part, and
inserting a plurality of second segments axially into a plurality of seats on the second tubular structure to form a second tubular active part, said first tubular active part and said second tubular active part facing each other.
